(19) United States
(12) Patent Application Publication
(10) Pub. No.: US 2004/0112903 A1
(43) Pub. Date: Jun. 17, 2004

(54) Bakeware and handle

(75) Inventors: Paul Angelo LoGiudice, Toledo, OH (US); Brian Demers, Rossford, OH (US); Jennifer Sievertsen, Maumee, OH (US); Amy Hook, Toledo, OH (US); Karen Lee, Toledo, OH (US)

Correspondence Address: FOLEY AND LARDNER, SUITE 500, 3000 K STREET NW, WASHINGTON, DC, 20007, US

(73) Assignee: Newell Operating Company

(21) Appl. No.: 10/318,242

(22) Filed: Dec. 13, 2002

(51) Int. Cl. A47J 27/00

(52) U.S. Cl. 220/573.1

(57) ABSTRACT

A bakeware device including a vessel including a side wall and a base surface for holding an item to be baked. A rim is connected to the top of the side wall and extends away from the side wall in a plane essentially parallel to the base surface. The rim includes an extended portion having silicon nubs to serve as a handle for the bakeware device.

### BACKGROUND

The present invention relates to cookware. More specifically, the present invention relates to bakeware and handles therefor.

Bakeware includes items of cookware that are typically used to cook food in the oven. Bakeware may include, for example, cookie sheets, cake pans, bread pans, bund forming pans, pizza sheets and muffin pans. Many items of conventional bakeware do not include handles. Many bakeware items are difficult and awkward to handle, because there is no designated surface to be gripped. It is often difficult to grab and remove a baking pan from an oven. Most traditional bakeware designs have straight edges that are difficult to grab when reaching for the pan in a hot oven. The slippery non-stick surfaces found on most pans are difficult to grip. As a result, users often have difficulty lifting bakeware, especially when bakeware is heated requiring the use of oven mitts or pot holders.

To date, there has been an attempt to overcome the handling difficulties associated with bakeware by adding handles to bakeware pans and sheets. Currently available bakeware includes handles that are molded (i.e., handles that are continuously attached to the base pan) and wire handles that are riveted to the pan. Wilton, Chicago Metallic, Pyrex, Anchor Hocking are a sample of companies that have incorporated some form of handle design into some of their bakeware lines.

Even the conventional items of bakeware having handles still have disadvantages. For example, no known bakeware handle provides access to the handle regardless of the orientation of the bakeware pan in the oven. Therefore, in many instances it is difficult to remove a pan from the oven, because the handle, or handles are not located in a position convenient for the user to grasp. Furthermore, in some instances, even if the handle can be grasped there is a tendency for the handle to slide out of the hand due to the smooth surface typically found on the handle. Gripping the handle is a particular problem if the bakeware user is wearing oven mitts or pot holders.

Accordingly, it is an object of the present invention to provide a bakeware item that improves upon the deficiencies of the conventional bakeware items including those disadvantages and deficiencies mentioned above.

### SUMMARY OF THE INVENTION

According to an embodiment of the present invention a bakeware apparatus is provided. The apparatus includes a vessel for holding an item to be baked. The vessel includes a base surface and a side wall. A rim is provided that is connected to the top of the side wall and extending away from the side wall. The rim includes a plurality of raised portions to facilitate gripping of the rim and carrying of bakeware apparatus.

According to another embodiment of the present invention, a bakeware device is provided that includes a vessel having a side wall and a base surface for holding an item to be baked. A rim is connected to the top of the side wall and extends away from the side wall in a plane essentially parallel to the base surface. The rim includes an extended portion having silicon inserts, the extended portion configured to serve as a handle for the bakeware device.

According to yet another embodiment of the present invention, a handle for an item of bakeware is provided. The handle is integrally formed with a rim of the bakeware item and includes a silicon insert protruding upward from the rim.

According to still another embodiment, a handle for a baking vessel is provided that includes a metal sheet extending outward from a rim of the baking vessel and a plurality of raised nubs protruding upward from the metal sheet.

In another embodiment of the present invention, a handle for a baking vessel is provided that includes silicon nubs protruding upward from a flat surface to thereby provide a gripping surface for a user.

According to an embodiment of the present invention, a bakeware apparatus is provided. The apparatus includes a vessel for holding an item to be baked. The vessel includes a base surface and a side wall; and a rim connected to the top of the side wall and extending away from the side wall. The rim includes a pair of extended portions located on opposite sides of the vessel so that at least one of the extended portions is accessible regardless of the orientation of the apparatus.

It is to be understood that both the foregoing general description and the following detailed description are exemplary and explanatory only and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 is a top plan view of a baking sheet according to an embodiment of the present invention.

FIG. 2 is a side view in elevation of the embodiment of FIG. 2.

FIG. 3 is a top plan view of a baking sheet according to an embodiment of the present invention.

FIG. 4 is a side view in elevation of the embodiment of FIG. 5.

FIG. 5 is top plan view of square baking pan according to an embodiment of the present invention.

FIG. 6 is a side view in elevation of the embodiment of FIG. 5.

FIG. 7 is a top plan view of a rectangular baking pan according to an embodiment of the present invention.

FIG. 8 is a side view in elevation of the embodiment of FIG. 7.

FIG. 9 is a top plan view of a round baking pan according to an embodiment of the present invention.

FIG. 10 is a side view in elevation of the embodiment of FIG. 9.

FIG. 11 is a top plan view of a bund forming pan according to an embodiment of the present invention.

FIG. 12 is a side view in elevation of the embodiment of FIG. 11.

FIG. 13 is a top plan view in elevation of a muffin pan according to an embodiment of the present invention.

FIG. 14 is a side view in elevation of the embodiment of FIG. 13.

### DETAILED DESCRIPTION

An embodiment of the present invention will be described below with reference to the accompanying drawings.

FIG. 1 discloses an embodiment of the present invention. FIG. 1 shows a generally rectangular baking sheet 10. The baking sheet 10 may be for example, thirteen inches long and nine inches wide. The depth of the baking sheet may vary according to the intended use. For example, a cookie sheet only requires a moderate depth of approximately 0.5 to 1 inches.

The sheet 10 includes a baking vessel 15. The cooking vessel 16 includes base surface 18 and a side wall 16. The wall 16 rises up from the base surface 18 and helps to retain food items on the base surface 18. In most instances, a flat base surface 18 is preferred. However, the base surface 18 may include many different shapes included a dimpled or cratered surface useful to inhibit food from sticking to the sheet. A rim 12 is connected to the top of the wall 16 and extends outwardly away from the vessel 15. The rim 12 preferably extends outwardly in a direction generally parallel to the base surface 18 of the sheet.

The baking sheet typically comprises a metal material. The shape of the pan can be formed by stamping or molding the metal. However, in alternative embodiments of the present invention the bakeware pan or sheet may be formed from glass, ceramic or stone.

The rim 12 is essentially an extension of the metal sheet used to form the pan. The rim 12 includes a non-extended portion 17 and an extended portion 11. The non-extended portion 17 is basically the same as a rim or edge of a conventional baking pan. The non-extended portion has a uniform width of a relatively short distance. The extended portion 11 functions as a handle for the sheet 10. The width of the extended portion 11 of the rim 12 is larger than the width of the non-extended portion 17. As shown in FIG. 1, the rim 12 gradually transitions from the non-extended portion 12 to the extended portion 11. The extended portion 11 gradually increases in width as the distance from the non-extended portion increases. The extended portion 11 is generally located in a region of the rim located at a corner of the sheet. In a particularly preferred embodiment of the invention, extended portions 11 of the rim 12 are provided at opposite corners of the sheet 10 as shown in FIG. 1. Furthermore, as shown in FIG. 1, the extended portion of the rim forms basically a “J” shape as it wraps around the corner of the sheet 10.

The extended portions 11 of the rim are preferably positioned so that at least one of the extended portions is accessible regardless of the orientation of the device.

As shown in FIG. 1, the handles 11 may include raised portions or nubs 13, 14. The raised portions improve the handling of the bakeware item because a contrasting surface profile is created. The hand of the user is less likely to slip off of the handle 11 or rim 12, because the raised portions provide a gripping surface.

In a preferred embodiment of the present invention, the raised portions 13, 14 have a surface texture that facilitates gripping. In an embodiment of the invention, silicon inserts are used to form the raised portions 13, 14. Silicon can be inserted into holes in the extended portion 11. Alternatively, the sheet 10 can be molded around the silicon or the silicon could be molded into the handles 11.

The raised portions can be provided in various sizes. The sizes could range from small round portions to large rectangular portions. In one example of the present invention, shown in FIG. 1, the raised portions include one larger portion 13 and two smaller portions 14. However, the raised portions can be provided in any number of configurations. For example, a baking pan may include one large portion or thirty smaller portions of silicone on each handle.

As shown in FIG. 1, the silicon insert may take the form of a “figure eight” having a raised ridge 13a running through the middle of the insert. The actual pattern design on the silicone can also vary from the “figure eight” design shown in FIG. 1. Additionally, materials other than silicon can be employed as the raised portions 13, 14 of the handles 11. Any material having a relatively soft touch and being temperature resistant would be suitable.

The silicon inserts in the handles increase the ease of grabbing and holding the pan, both when the pan is cool (and user is not wearing an oven mitt) and when the pan is hot (and the user is wearing an oven mitt).

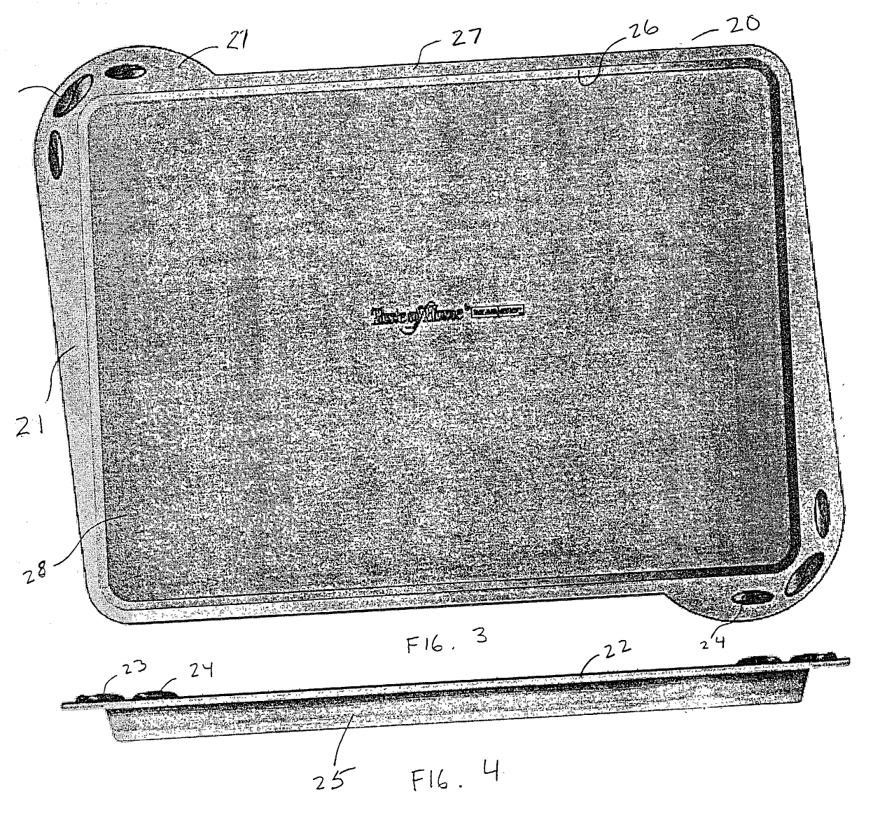

FIGS. 3-16 disclose further alternative embodiments of the present invention. The description of the embodiment FIG. 1 applies equally to the embodiments shown in FIGS. 3-16. In particular, the description of the raised portions 13, 14 above, applies equally to the raised portions of the embodiments of bakeware shown in FIGS. 3-16 and, is omitted from the discussion below for simplicity.

FIG. 3 discloses an alternative embodiment of the present invention. FIG. 3 shows a baking sheet 20. The baking sheet 20 is preferably 13 inches by 18 inches. The baking sheet includes a baking vessel 25 having a base surface 28 and a side wall 26. As mentioned above, the base surface 28 may include many different shapes included a dimpled or cratered surface useful to inhibit food from sticking to the sheet. A rim 22 is connected to the top of the wall 26 and extends outwardly away from the vessel 25. The rim 22 preferably extends outwardly in a direction generally parallel to the base surface 28 of the sheet. As mentioned above, the baking sheet typically comprises a metal material. However, other suitable materials may be used.

The rim 22 includes a non-extended portion 27 and an extended portion 21. The non-extended portion 27 is basically the same as a rim or edge of a conventional baking pan. The non-extended portion has a uniform width of a relatively short distance. The extended portion 21 functions as a handle for the sheet 20. The width of the extended portion 21 of the rim 22 is larger than the width of the non-extended portion 27. As shown in FIG. 3, the rim 22 gradually transitions from the non-extended portion 27 to the extended portion 21. The extended portion 21 gradually increases in width as the distance from the non-extended portion increases. The extended portion 21 is generally located in a region of the rim located at a corner of the sheet. In a particularly preferred embodiment of the invention, extended portions 21 of the rim 22 are provided at opposite corners of the sheet 20 as shown in FIG. 3. Furthermore, as shown in FIG. 3, the extended portion of the rim forms basically a “J” shape as it wraps around the corner of the sheet 20.

The extended portions 11 of the rim are preferably positioned so that at least one of the extended portions is accessible regardless of the orientation of the device.

As shown in FIG. 3, the handles or extended portions 21 may include raised portions 23, 24. The description of the raised portions 13, 14 above, applies with equal force to the raised portions of the embodiment shown in FIGS. 3 and 4.

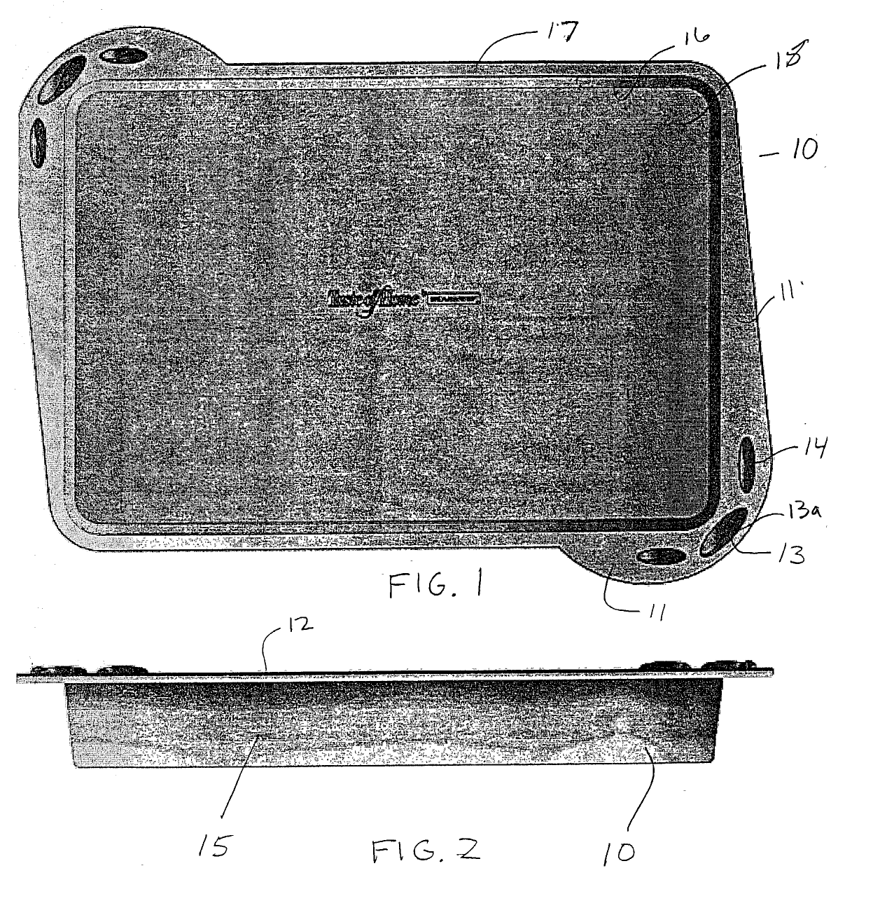

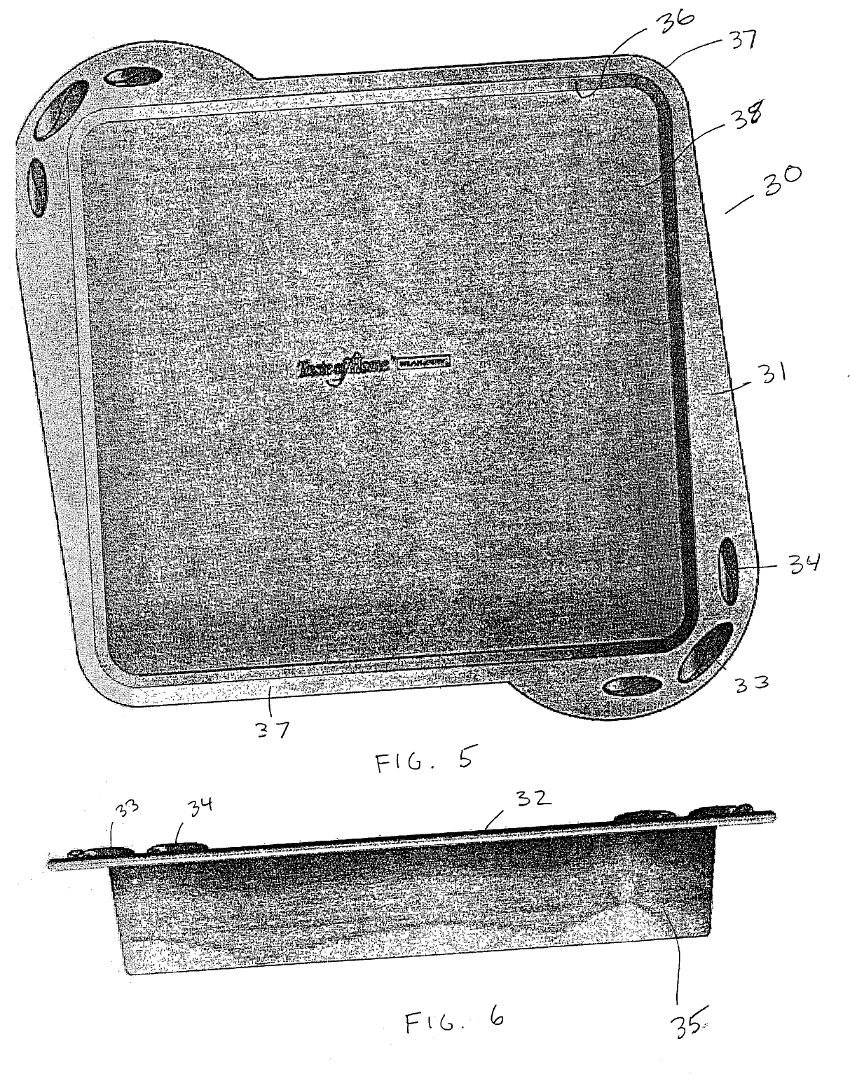

FIG. 5 discloses another embodiment of the present invention. FIG. 5 shows a baking pan 30. The baking pan 30 may be, for example, eight inches by eight inches. The baking pan shown in FIGS. 5 and 6 is generally similar to the embodiments shown in FIGS. 1-4 and includes a baking vessel 35 having a base surface 38 and a side wall 36.

As mentioned above, the base surface 28 may include many different shapes included a dimpled or cratered surface useful to inhibit food from sticking to the pan. A rim 32 is connected to the top of the wall 36 and extends outwardly away from the vessel 35. The rim 32 preferably extends outwardly in a direction generally parallel to the base surface 38 of the pan 30. As mentioned above, the baking pan 30 typically comprises a metal material. However, other suitable materials may be used.

The rim 32 includes a non-extended portion 37 and an extended portion 31. The non-extended portion 37 is basically the same as a rim or edge of a conventional baking pan. The non-extended portion 31 has a uniform width of a relatively short distance. The extended portion 32 functions as a handle for the pan 30. The width of the extended portion 31 of the rim 32 is larger than the width of the non-extended portion 37. As shown in FIG. 5, the rim 32 gradually transitions from the non-extended portion 37 to the extended portion 31. The extended portion 31 gradually increases in width as the distance from the non-extended portion increases. The extended portion 31 is generally located in a region of the rim located at a corner of the pan. In a particularly preferred embodiment of the invention, extended portions 31 of the rim 32 are provided at opposite corners of the pan 30 as shown in FIG. 5. Furthermore, as shown in FIG. 5, the extended portion of the rim forms basically a “J” shape as it wraps around the corner of the pan 30.

As shown in FIG. 5, the handles or extended portions 31 may include raised portions 33, 34. The description of the raised portions 13, 14 above, applies with equal force to the raised portions of the embodiment shown in FIGS. 5 and 6.

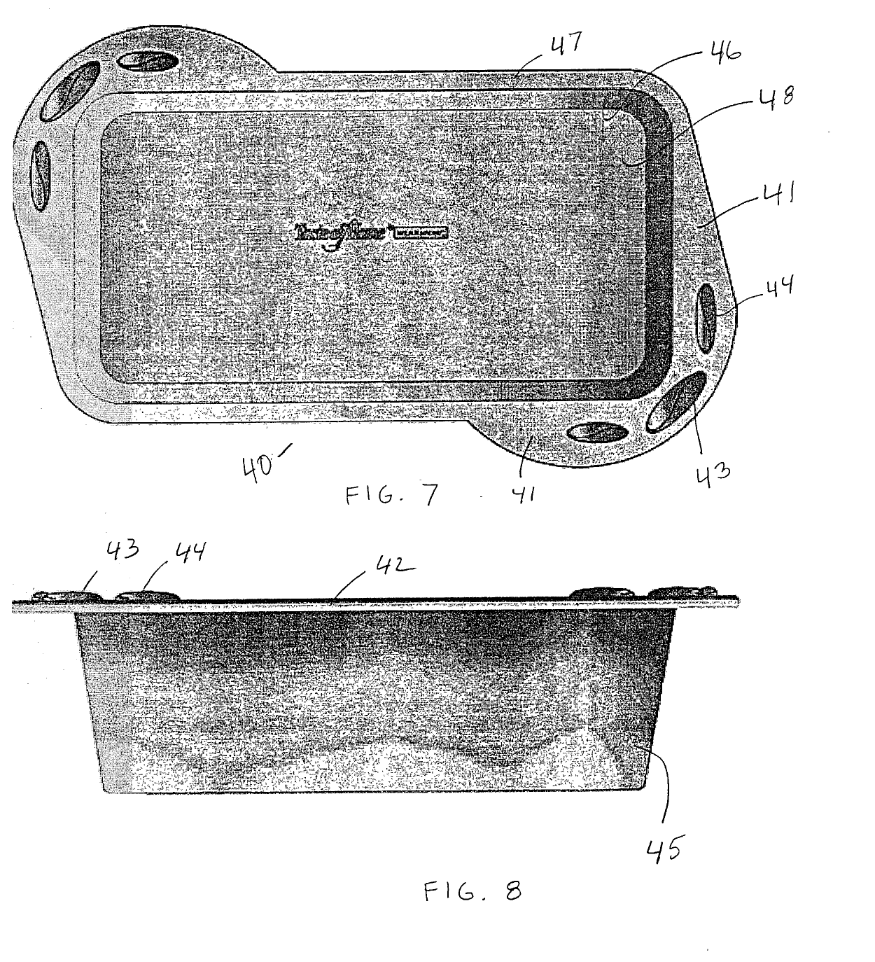

FIG. 7 discloses yet another alternative embodiment of the present invention. FIG. 7 shows a baking pan 40 for cooking, for example, bread dough or the like. The baking pan shown in FIGS. 7 and 8 is generally similar to the embodiments shown in FIGS. 1-6 and includes a baking vessel 45 having a base surface 48 and a side wall 46.

As mentioned above, the base surface 48 may include many different shapes included a dimpled or cratered surface useful to inhibit food from sticking to the pan. A rim 42 is connected to the top of the wall 46 and extends outwardly away from the vessel 45. The rim 42 preferably extends outwardly in a direction generally parallel to the base surface 48 of the pan 40. As mentioned above, the baking pan 40 typically comprises a metal material. However, other suitable materials may be used.

The rim 42 includes a non-extended portion 47 and an extended portion 41. The non-extended portion 47 is basically the same as a rim or edge of a conventional baking pan. The non-extended portion 47 has a uniform width of a relatively short distance. The extended portion 41 functions as a handle for the pan 40. The width of the extended portion 41 of the rim 42 is larger than the width of the non-extended portion 47. As shown in FIG. 7, the rim 42 gradually transitions from the non-extended portion 47 to the extended portion 41. The extended portion 41 gradually increases in width as the distance from the non-extended portion increases. The extended portion 41 is generally located in a region of the rim located at a corner of the pan. In a particularly preferred embodiment of the invention, extended portions 41 of the rim 42 are provided at opposite corners of the pan 40 as shown in FIG. 7. Furthermore, as shown in FIG. 7, the extended portion of the rim forms basically a “J” shape as it wraps around the corner of the pan 40.

As shown in FIG. 7, the handles or extended portions 41 may include raised portions 43, 44. The description of the raised portions 13, 14 above, applies with equal force to the raised portions of the embodiment shown in FIGS. 7 and 8.

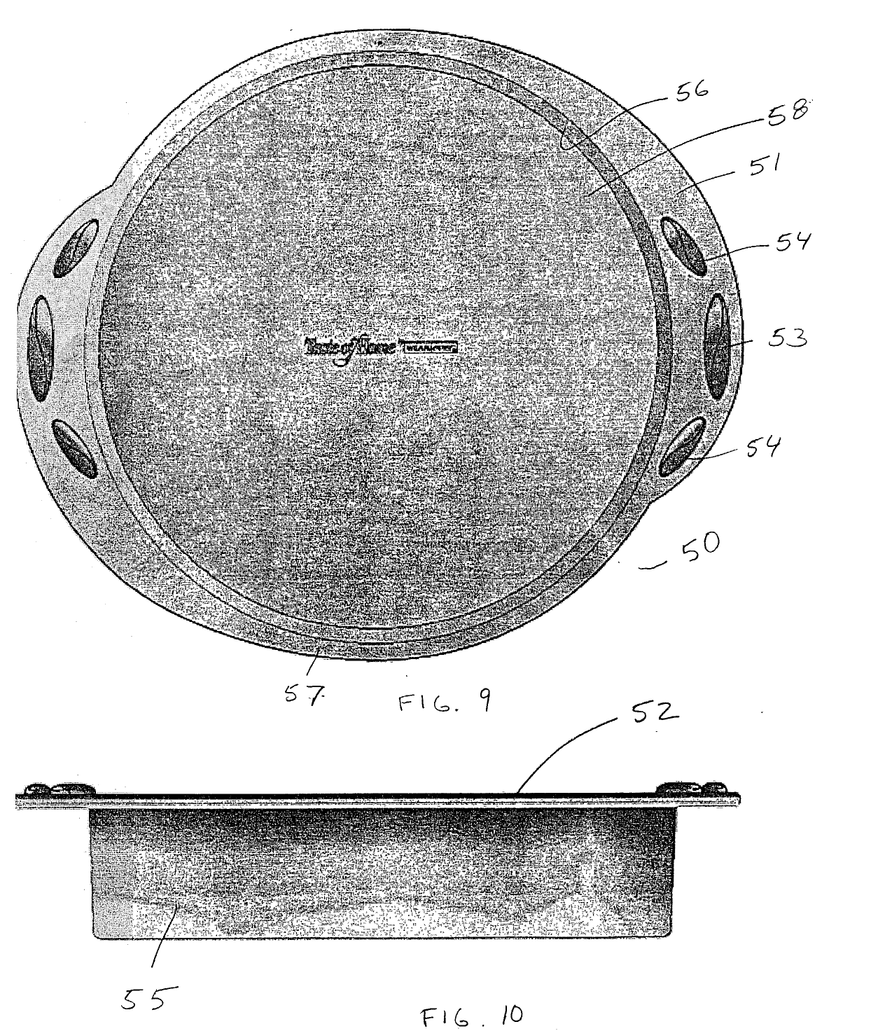

FIG. 9 discloses still another alternative embodiment of the present invention. FIG. 9 shows a round or circular baking pan 50 for cooking, for example, cake layers or the like. The baking pan 50 may be, for example, eight inches in diameter. Except for the shape, the baking pan shown in FIGS. 9 and 10 is generally similar to the embodiments shown in FIGS. 1-8 and includes a baking vessel 55 having a base surface 58 and a side wall 56.

As mentioned above, the base surface 58 may include many different shapes included a dimpled or cratered surface useful to inhibit food from sticking to the pan. A rim 52 is connected to the top of the wall 56 and extends outwardly away from the vessel 55. The rim 52 preferably extends outwardly in a direction generally parallel to the base surface 58 of the pan 50. As mentioned above, the baking pan 50 typically comprises a metal material. However, other suitable materials may be used.

The rim 52 includes a non-extended portion 57 and an extended portion 51. The non-extended portion 57 is basically the same as a rim or edge of a conventional baking pan. The non-extended portion 57 has a uniform width of a relatively short distance. The extended portion 51 functions as a handle for the pan 50. The width of the extended portion 51 of the rim 52 is larger than the width of the non-extended portion 57. As shown in FIG. 9, the rim 52 gradually transitions from the non-extended portion 57 to the extended portion 51. The extended portion 51 gradually increases in width as the distance from the non-extended portion increases. In a particularly preferred embodiment of the invention, extended portions 51 of the rim 52 are provided at opposite sides of the pan 50 as shown in FIG. 9.

As shown in FIG. 9, the handles or extended portions 51 may include raised portions 53, 54. The description of the raised portions 13, 14 above, applies with equal force to the raised portions of the embodiment shown in FIGS. 9 and 10.

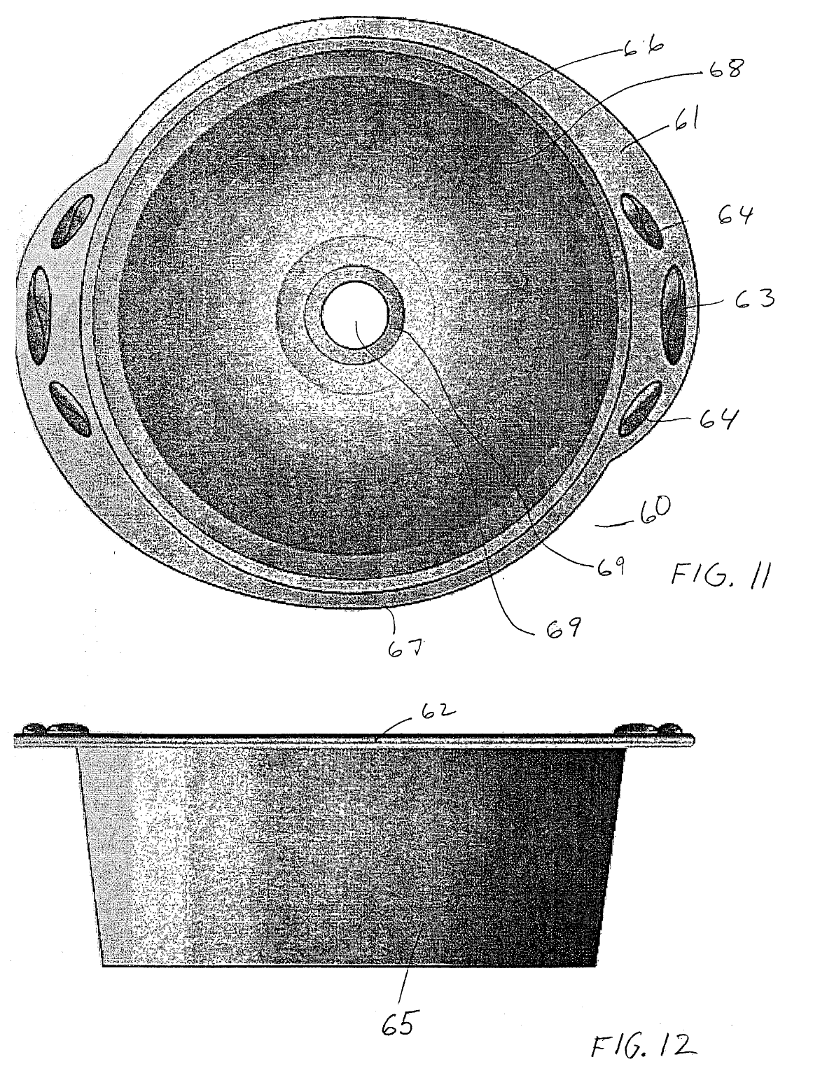

FIG. 11 discloses an alternative embodiment of the present invention. FIG. 11 shows a baking pan 60 with a centrally located opening 69. The baking pan 60 can be used, for example, to bake bund cakes. The baking pan 60 shown in FIGS. 11 and 12 is generally similar to the embodiment of the present invention shown in FIGS. 9 and 10 and includes a baking vessel 65 having a base surface 68 and a side wall 66. An interior wall 69 is provided around the opening 69.

As mentioned above, the base surface 68 may include many different shapes included a dimpled or cratered surface useful to inhibit food from sticking to the pan. A rim 62 is connected to the top of the wall 66 and extends outwardly away from the vessel 66. The rim 62 preferably extends outwardly in a direction generally parallel to the base surface 68 of the pan 60. As mentioned above, the baking pan 60 typically comprises a metal material. However, other suitable materials may be used.

The rim 62 includes a non-extended portion 67 and an extended portion 61. The non-extended portion 67 is basically the same as a rim or edge of a conventional baking pan. The non-extended portion 67 has a uniform width of a relatively short distance. The extended portion 61 functions as a handle for the pan 60. The width of the extended portion 61 of the rim 62 is larger than the width of the non-extended portion 67. As shown in FIG. 11, the rim 62 gradually transitions from the non-extended portion 67 to the extended portion 61. The extended portion 61 gradually increases in width as the distance from the non-extended portion increases. In a particularly preferred embodiment of the invention, extended portions 61 of the rim 62 are provided at opposite sides of the pan 60 as shown in FIG. 11.

As shown in FIG. 11, the handles or extended portions 61 may include raised portions 63, 64. The description of the raised portions 13, 14 above, applies with equal force to the raised portions of the embodiment shown in FIGS. 11 and 12.

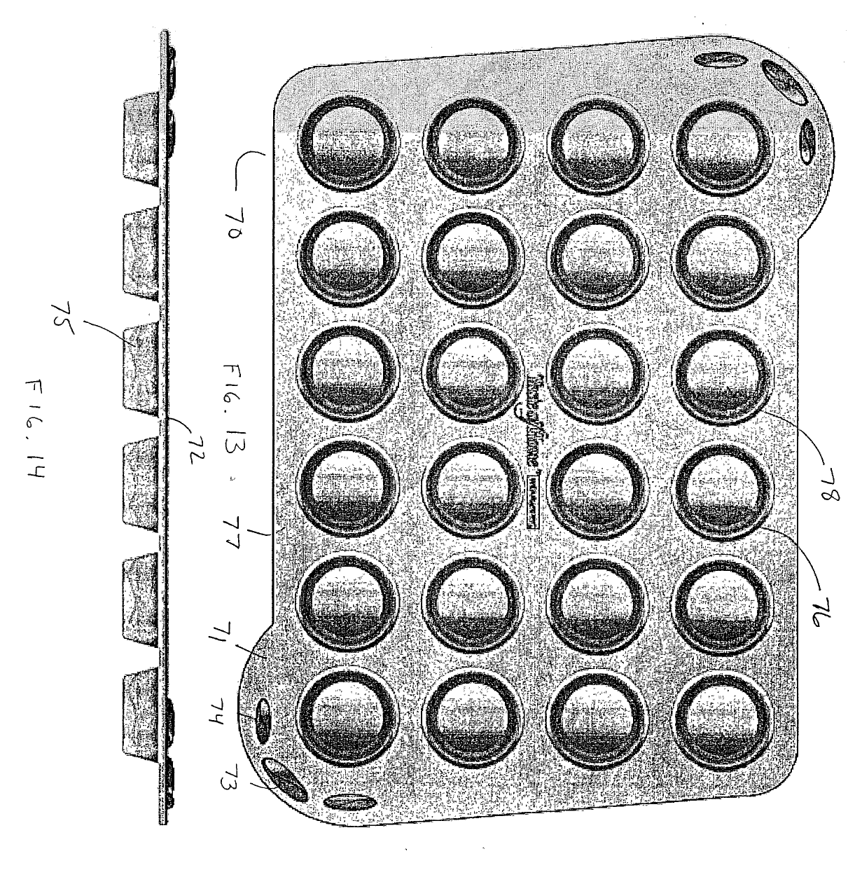

FIG. 13 discloses another alternative embodiment of the present invention. FIG. 13 shows a muffin pan 70. The muffin pan 70 preferably includes a baking vessel 75 for retaining batter for cupcakes or muffins, for example. The baking vessel 75 has a base surface 78 and a side wall 76. As shown in FIG. 13, a plurality of vessels 75 may be provided. In the embodiment shown in FIG. 13, twenty-four baking vessels 75 are provided. A rim 77 is connected to the top of the wall 76 of each vessel. The rim 77 preferably extends in a direction generally parallel to the base surface 78 of the vessel. The muffin pan typically comprises a metal material. However, other suitable materials may be used.

The rim 72 includes a non-extended portion 77 and an extended portion 71. The non-extended portion 77 is basically the same as a rim or edge of a conventional muffin pan. The non-extended portion has a uniform width of a relatively short distance. The extended portion 71 functions as a handle for the pan 70. The width of the extended portion 71 of the rim 72 is larger than the width of the non-extended portion 77. As shown in FIG. 13, the edge of the rim 72 gradually transitions from the non-extended portion 77 to the extended portion 71. The extended portion 71 gradually increases in width as the distance from the non-extended portion increases. The extended portion 71 is generally located in a region of the rim located at a corner of the pan. In a particularly preferred embodiment of the invention, extended portions 71 of the rim 72 are provided at opposite corners of the pan 70 as shown in FIG. 13. Furthermore, as shown in FIG. 13, the extended portion of the edge of the rim forms basically a “J” shape as it wraps around the corner of the pan 70.

As shown in FIG. 13, the handles or extended portions 71 may include raised portions 73, 74. The description of the raised portions 13, 14 above, applies with equal force to the raised portions of the embodiment shown in FIGS. 13 and 14.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined a set forth in the following claims.

What is claimed is:

1. A bakeware apparatus comprising:
a vessel for holding an item to be baked,
the vessel including a base surface and a side wall; and
a rim connected to the top of the side wall and extending away from the side wall;
wherein the rim includes a plurality of raised portions to facilitate gripping of the rim and carrying.

2. The apparatus of claim 1, further comprising a plurality of vessels for holding items to be baked.

3. The apparatus of claim 1, wherein the raised portions comprise silicon.

4. The apparatus of claim 1, wherein each raised portion comprises a separate material fitted into openings in the rim.

5. The apparatus of claim 1, wherein the rim includes a portion extending away from the vessel a further distance than the remaining portion of the rim to thereby form a handle for gripping the apparatus.

6. The apparatus of claim 1, wherein the raised portions are located in the extending portion of the rim.

7. A bakeware device comprising:
a vessel including a side wall and a base surface for holding an item to be baked;
a rim connected to the top of the side wall and extending away from the side wall in a plane essentially parallel to the base surface;
wherein the rim includes an extended portion having silicon inserts, the extended portion configured to serve as a handle for the bakeware device.

8. The device of claim 7, wherein the rim includes a pair of extended portions located on opposite sides of the vessel so that at least one of the extended portions is accessible regardless of the orientation of the device.

9. The device of claim 7, wherein the rim includes four corners and wherein a pair of extended portions are located on opposite corners so that at least one of the extended portions is accessible regardless of the orientation of the device.

10. A handle for an item of bakeware, wherein the handle is integrally formed with a rim of the bakeware item and includes a silicon insert protruding upward from the rim.

11. A handle for a baking vessel comprising:
a metal sheet extending outward from a rim of the baking vessel; and
a plurality of raised nubs protruding upward from the metal sheet.

12. The handle of claim 11, wherein the nubs comprise silicon.

13. The handle of claim 12, wherein the nubs are fitted into openings in the sheet.

14. A handle for a baking vessel including silicon nubs protruding upward from a flat surface to thereby provide a gripping surface for a user.

15. A bakeware apparatus comprising:
a vessel for holding an item to be baked,
the vessel including a base surface and a side wall; and
a rim connected to the top of the side wall and extending away from the side wall;
wherein the rim includes a pair of extended portions located on opposite sides of the vessel so that at least one of the extended portions is accessible regardless of the orientation of the apparatus.

16. The apparatus of claim 15, wherein the extend portions include a plurality of raised portions to facilitate gripping of the rim and carrying.

17. The apparatus of claim 16, wherein the raised portions comprise silicon.
